(19) United States
(12) Patent Application Publication
(10) Pub. No.: US 2022/0099318 A1
(43) Pub. Date: Mar. 31, 2022

(54) VENTILATION UNIT

(71) Applicant: Peakvent AS, Oslo (NO)

(72) Inventor: Morten GULLIKSEN, Oslo (NO)

(21) Appl. No.: 17/432,881

(22) PCT Filed: Feb. 21, 2020
(86) PCT No.: PCT/NO2020/050048

§ 371 Date: Aug. 20, 2021

(30) Foreign Application Priority Data
Feb. 22, 2019 (NO) 20190246
Apr. 17, 2019 (NO) 20190522

(51) Int. Cl. F24F 7/06; F24F 12/00; F04D 29/26; F04D 29/54; F04D 25/08; F04D 29/70; F24F 13/28; F24F 7/00

(52) U.S. Cl. CPC F24F 7/065; F24F 12/001; F04D 29/26; F04D 29/545; F24F 2203/104; F04D 29/703; F24F 13/28; F24F 2007/001; F04D 25/08

(57) ABSTRACT

A dual mode impeller assembly and ventilation device and a system, is provided, comprising one or more of a unit casing, a compact rotating heat exchange unit, a dual mode impeller, and a filter unit, and a system for monitoring and control of such ventilation device.

The present invention relates to ventilation units for air exchange in rooms, primarily exchanging air between an outdoor environment and a room in a house.

Air ventilation is mandatory today when a house is built for being used by people or animal. Often a ventilation unit is required to comprise heat exchange functionality.

It is challenging to design a ventilation unit which provides both high efficiency and high air flow when available space is limited. There is always a trade-off between the size of the ventilation device, the air flow, the thermal efficiency and the noise. Some traditional embodiments of heat recovery ventilation units use a 2 mode operation where the airflow is alternated to exchange heat via a porous medium with a temperature gradient, by alternating the direction of the fan or fans. The time loss related to changing fan directions reduces the total effective flow throughput, and the noise becomes irregular. Geometric restrictions makes axial impellers the natural choice for such principles, however axial fans have low pressure capacity due to aerodynamic conditions around the fan blades. Major drawbacks with this principle therefore relates to high flow resistance which in turn gives low flow throughput and noise emission. Typically also two impellers (and motors), one for each direction, are required.

Further prior art techniques are cross- and/or counter-flow ventilation units, often also comprising heat exchangers. A major drawback with this principle is clogging of the channels as condense build up. A self-amplifying uneven flow occurs as a result, and the system must be reset by a de-freezing process that reduces capacity. It is also difficult to make such devices compact as the flows must be separated and fed into the heat exchanging channels, thus requiring extra space. Cross- and/or counter-flow heat exchangers can therefore not be adapted to fit into, for example, a standard circular house ventilation duct without significant loss of performance.

Standalone ventilation units and heat exchangers in the marked today almost exclusively uses two motor/impellers that are very difficult to arrange without wasting valuable volume to ducting. Common to all ventilation units are still the tradeoffs related to size, air flow capacity, thermal efficiency, and noise. The smaller the ventilation device is, the more noise it emits when handling the same amount of air.

The present invention seeks to accommodate one or more of the three key components for ventilation unit: Fifter, fan and heat exchanger within a standard circular venthation duct in the wall of a house, and within the wail thickness of an insulated house.

The overall goal for the present invention is therefore to provide an extremely compact and complete ventilation device and system for room ventilation wherein the mentioned tradeoffs are eliminated or considerably reduced.

The present invention, a ventilation device and a system, is provided comprising in a first embodiment a unit casing and a compact rotating heat exchange unit, a dual mode fan, a filter unit, arranged inside the unit casing, and a first embodiment of a room unit. The parts comprised in the ventilation device provides a dual air flow channel design, enabling a simultaneous dual directional and optimized air flow through the ventilation device.

In a further second embodiment the ventilation device and system is provided comprising a unit casing, a dual mode fan assembly, and an optional filter unit, arranged inside the unit casing and a second embodiment of a room unit, enabling a simultaneous dual directional and optimized air flow through the ventilation device optimized for ventilating houses and rooms when there is net surplus heat inside the house/rooms. The internal duct assembly may comprise a static filter.

In yet a further third embodiment the ventilation device of either the first or second embodiment is optimized for arrangement in thick wall structures, comprising duct extender assembly where the unit casing is correspondingly extended to provide a length corresponding to the thickness of the wall.

The first and second embodiment may be provided as multi-operation-mode device wherein the rotating heat exchange unit and the room unit of the first embodiment is exchangeable with a summer mode assembly comprising the internal duct assembly and optionally the large static filter and the room unit of the second embodiment, without needing to dismount the unit casing.

The dual mode fan may in a fourth embodiment of the invention be combined with a counter flow heat exchanger, providing an optimized unit for drying out rooms having a moisture and/or radon problem, such as in cellars.

Additional features and advantages of the present invention are described in, and will be apparent from, the following brief description of the figures and the following detailed description, wherein:

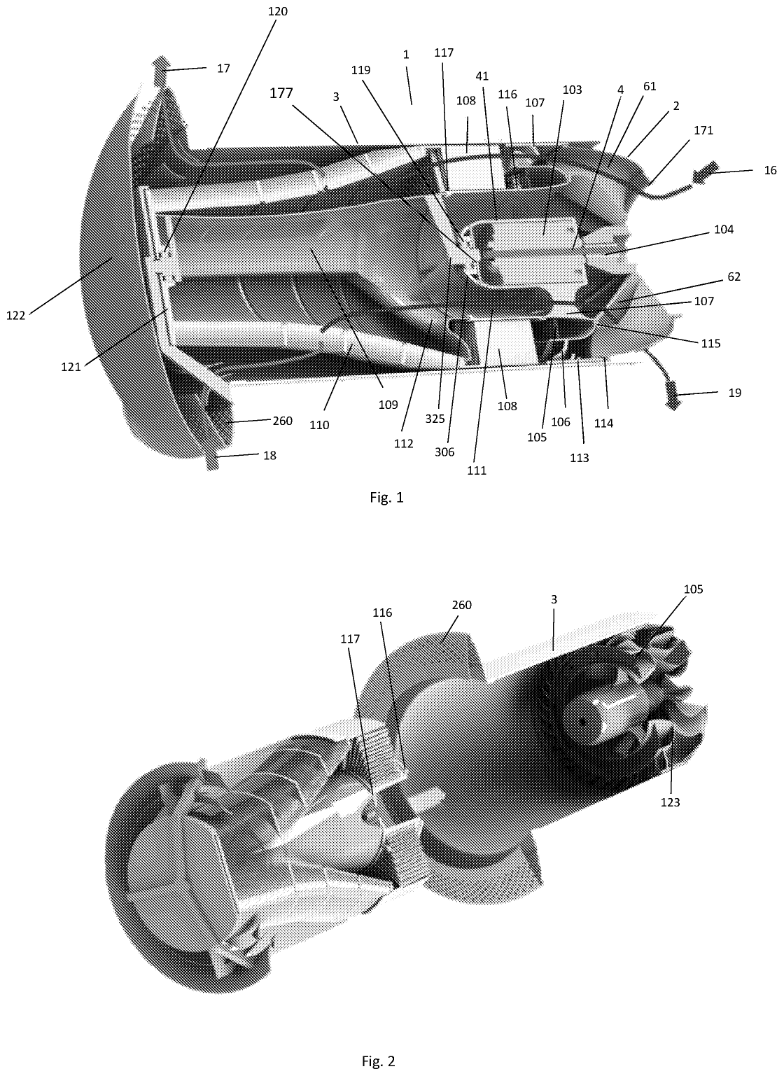

FIG. 1—Ventilation unit cross section

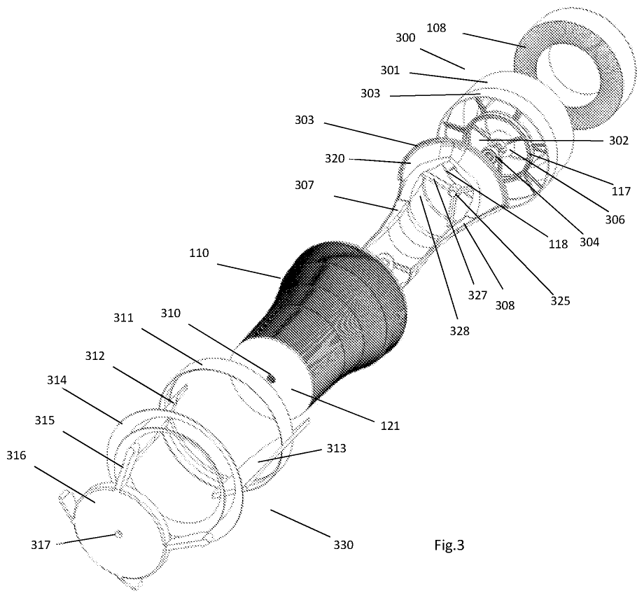

FIG. 2—Ventilation unit with heat exchange module in an outdrawn position

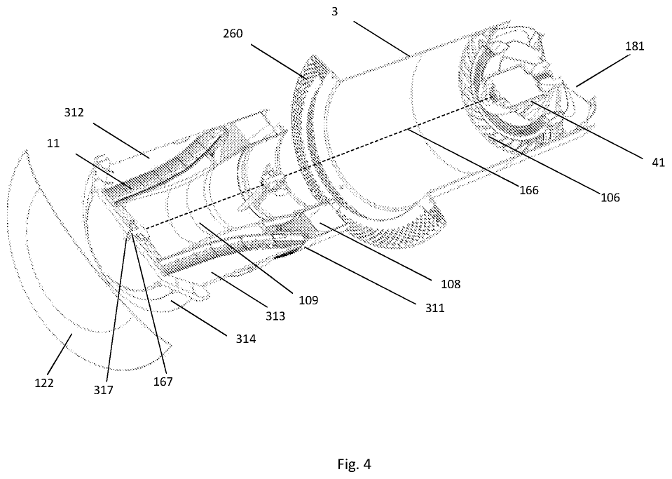

FIG. 3—Internal elements filter to end cap; Winter heat exchange module, exploded view

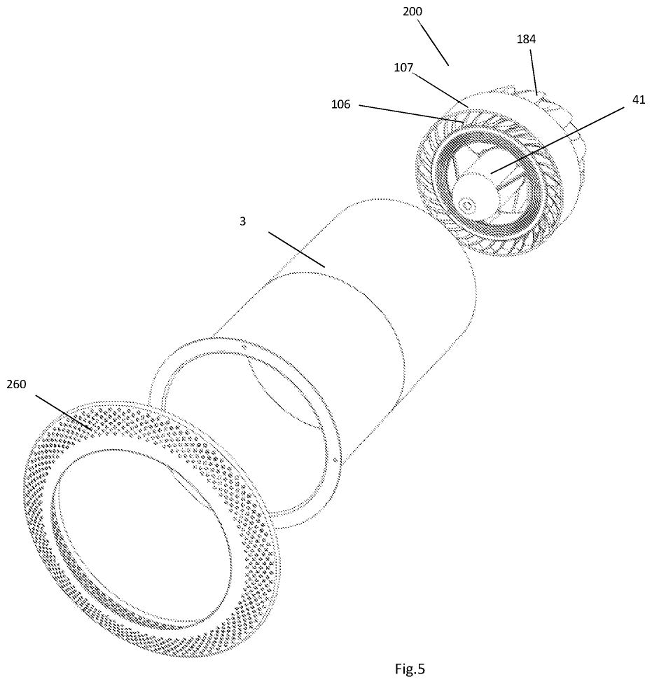

FIG. 4—Ventilation unit, cross section, heat exchange module in an outdrawn position

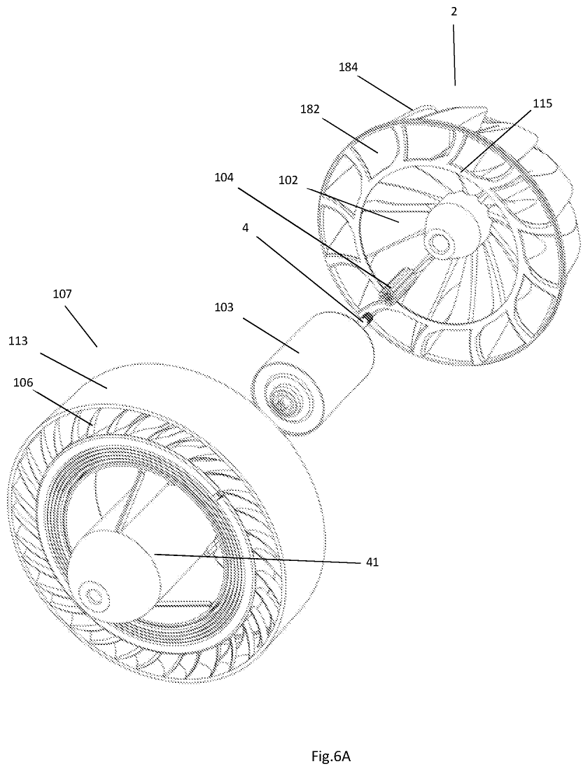

FIG. 5—Ventilation unit without module, exploded view of impeller module, casing and end protection cap

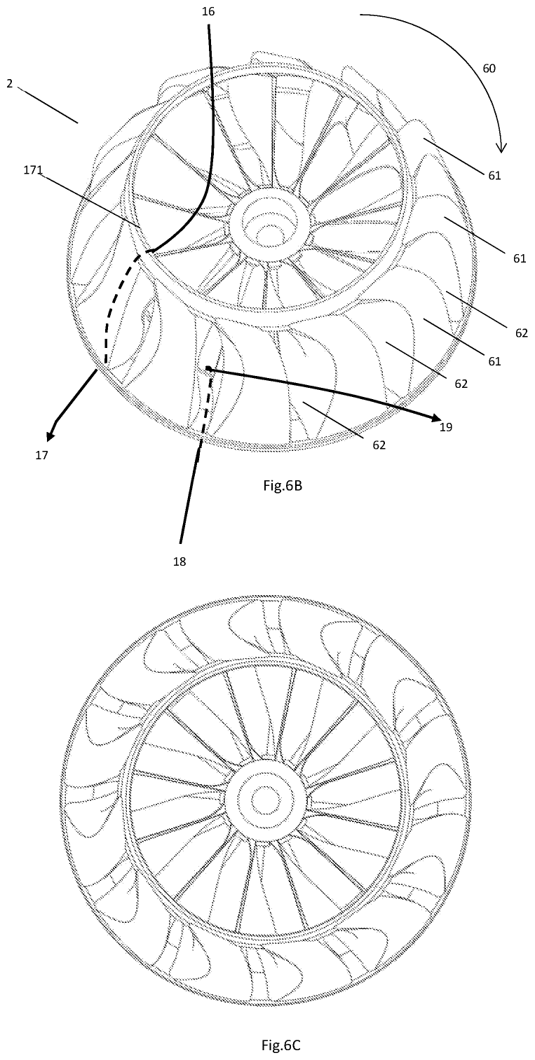

FIG. 6A—Dual mode fan an assembly, exploded view

FIG. 6B—Dual mode impeller, outside oblique view

FIG. 6C—Dual mode impeller, outside view from above

FIG. 6D—Air flow to and from impeller, schematic view

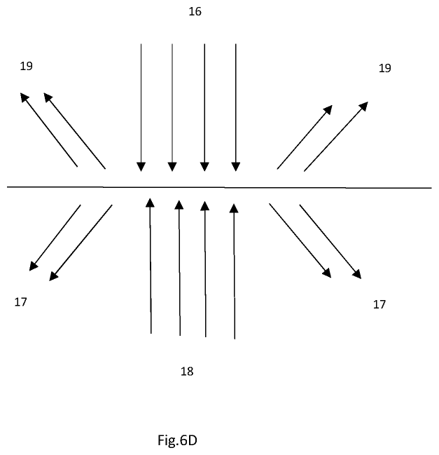

FIG. 7—One embodiment of flow restrictor design

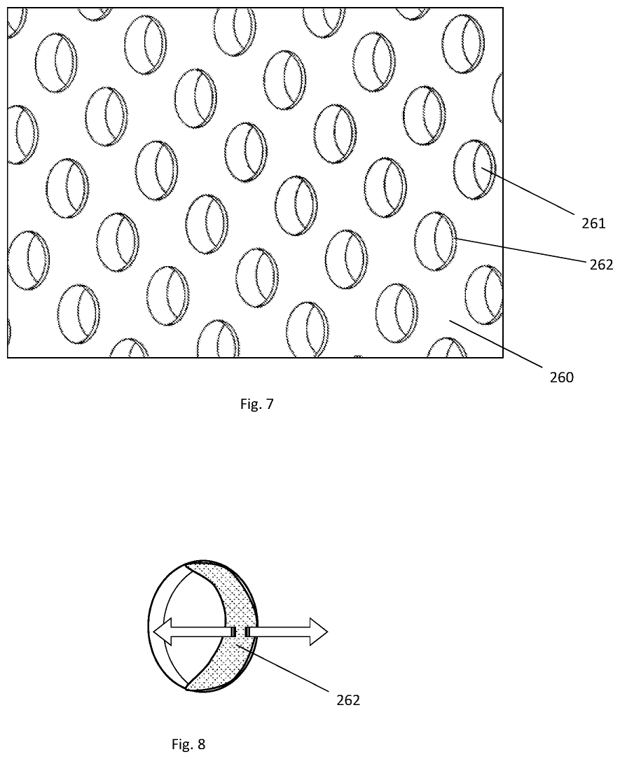

FIG. 8—Detail of flow restrictor in FIG. 7

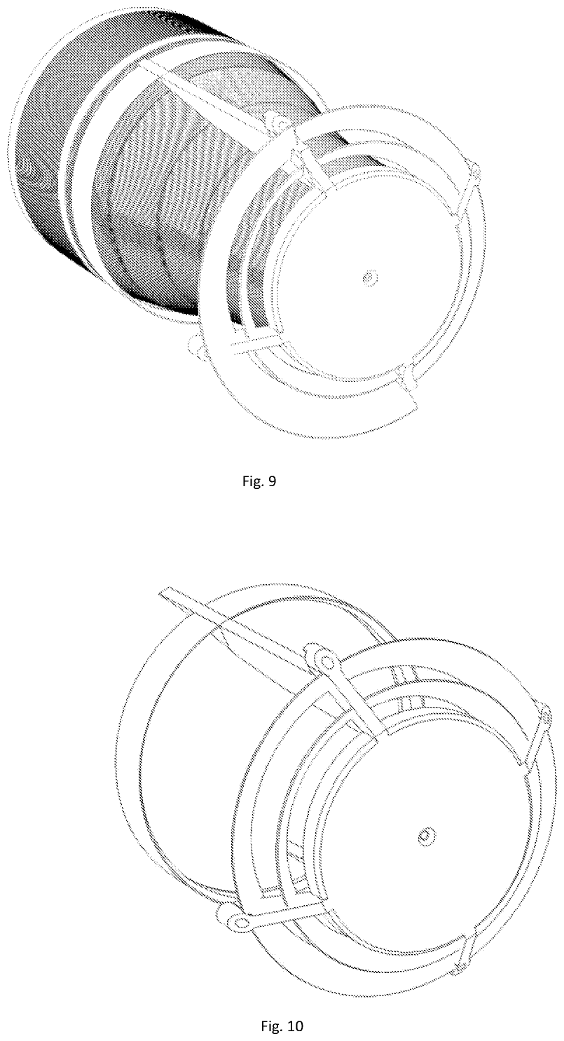

FIG. 9—Heat exchange module and outside flow separator knifes

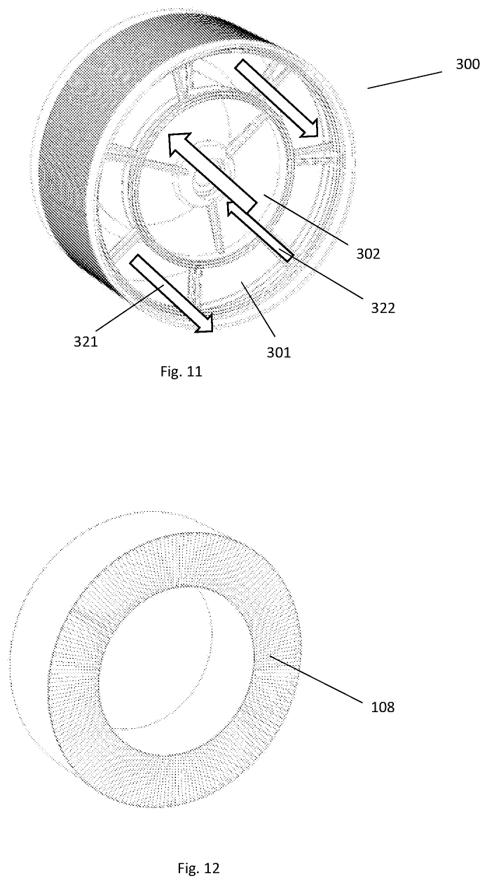

FIG. 10—Static outside flow separator knifes

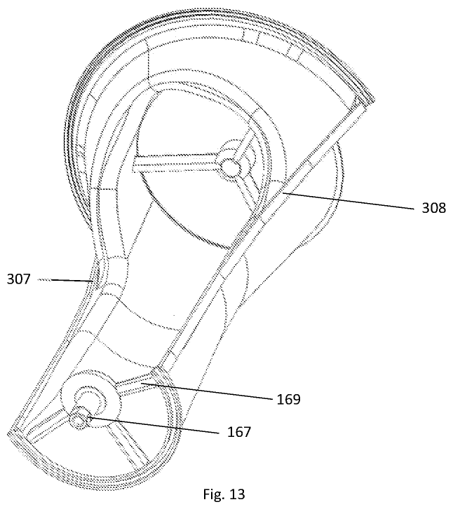

FIG. 11—Filter unit

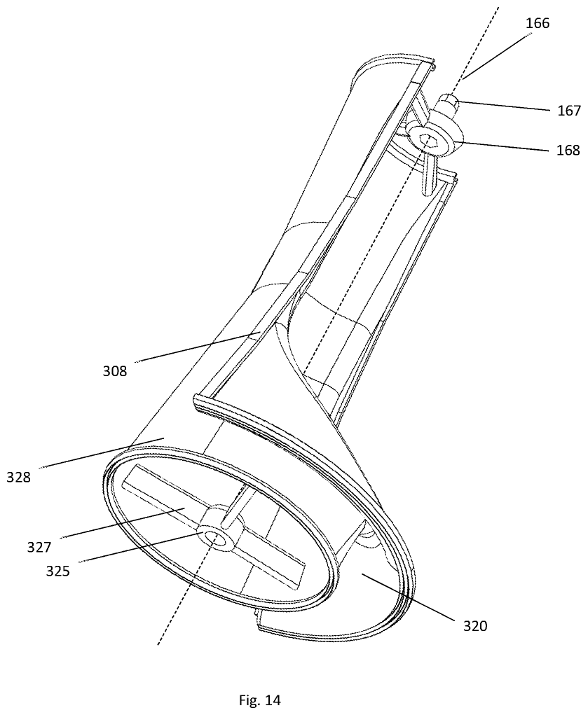

FIG. 12—Filter

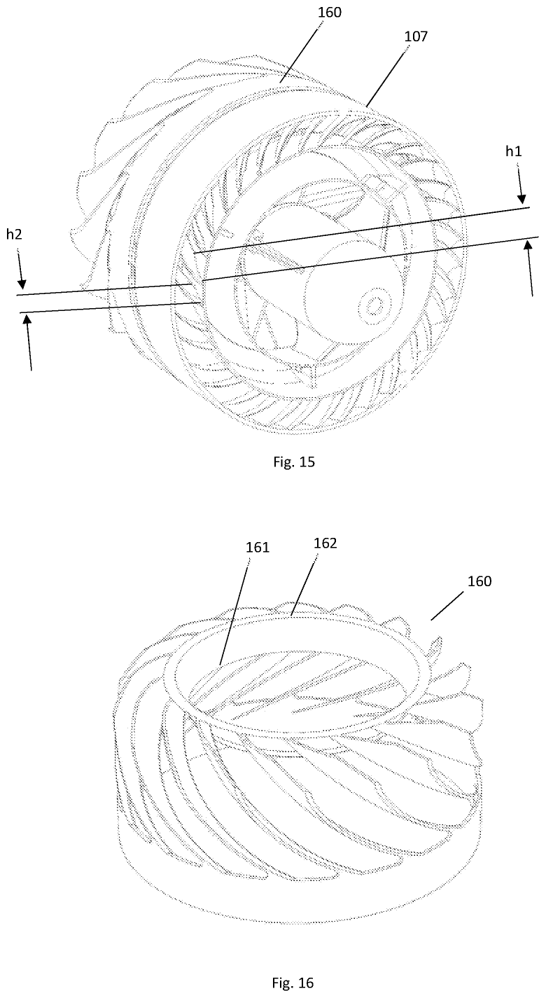

FIG. 13—Center duct structure, bottom oblique view

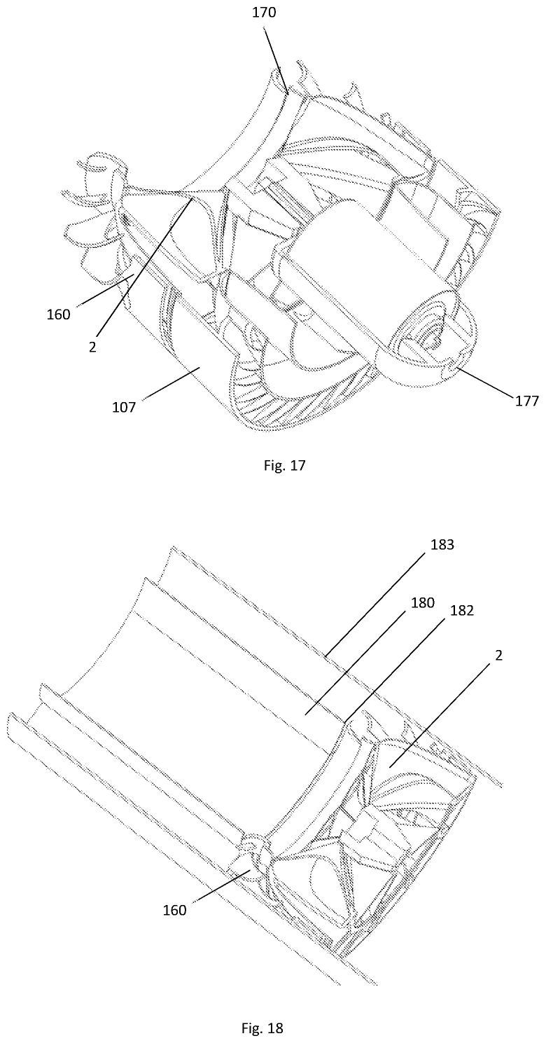

FIG. 14—Center duct structure, top oblique view

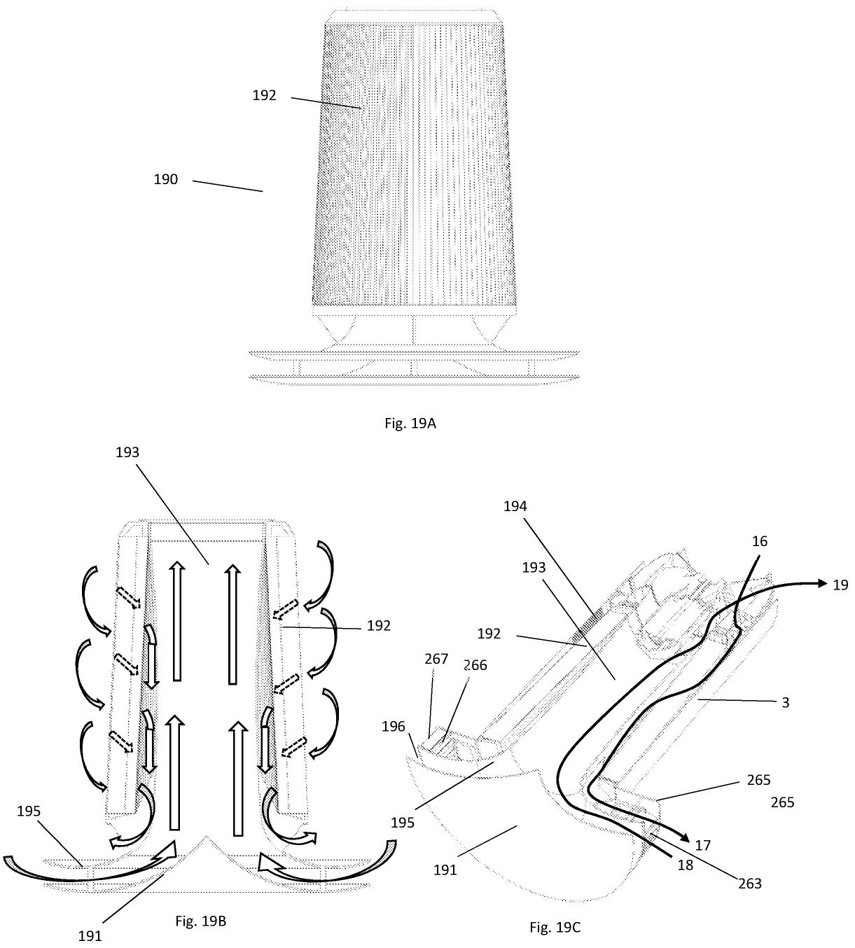

FIG. 15—Outer air director unit for duct extender version of ventilation device and fan assembly.

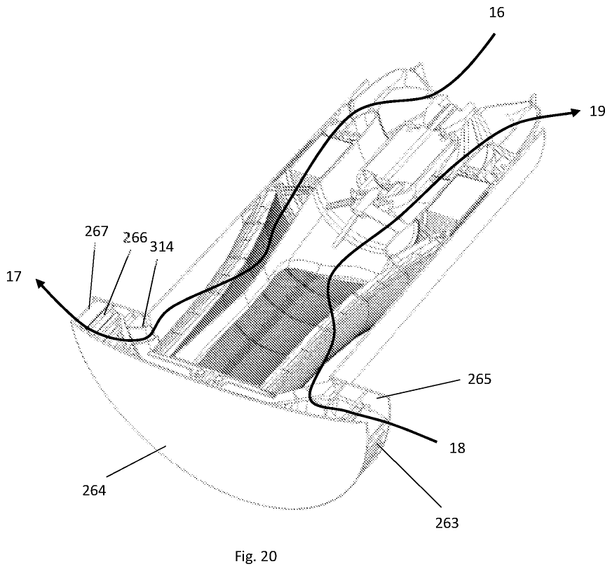

FIG. 16—Outer air director

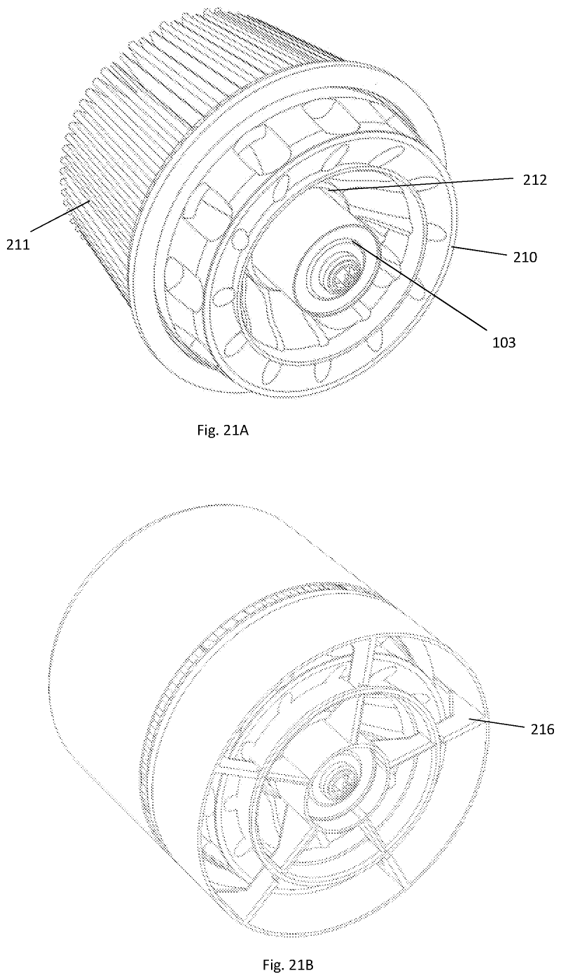

FIG. 17—Cross section of dual mode fan assembly and outer air director

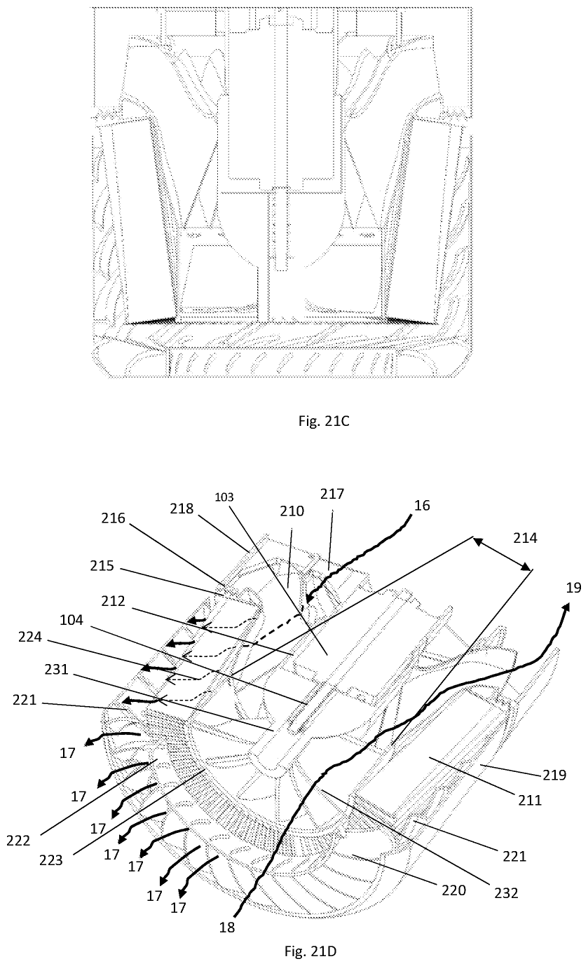

FIG. 18—Cross section of dual mode impeller, outer air director, and sleeve extender.

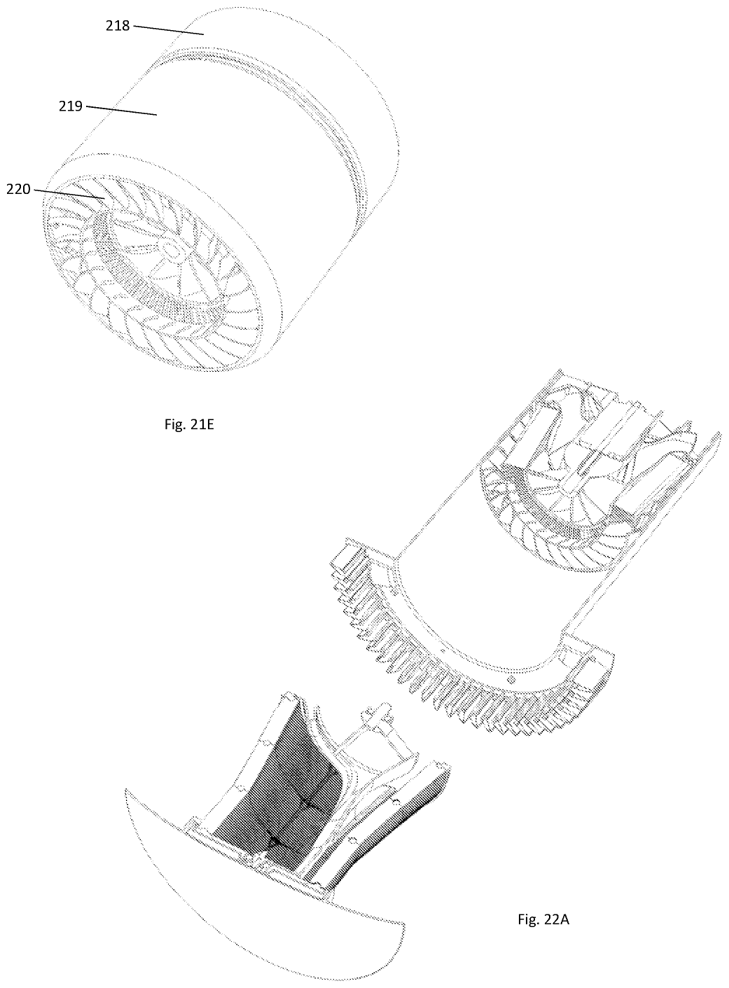

FIG. 19A—Summer module and room unit

FIG. 19B—Summer module and room unit, cross section FIG. 19C—Summer module, fan unit, and room unit, cross section

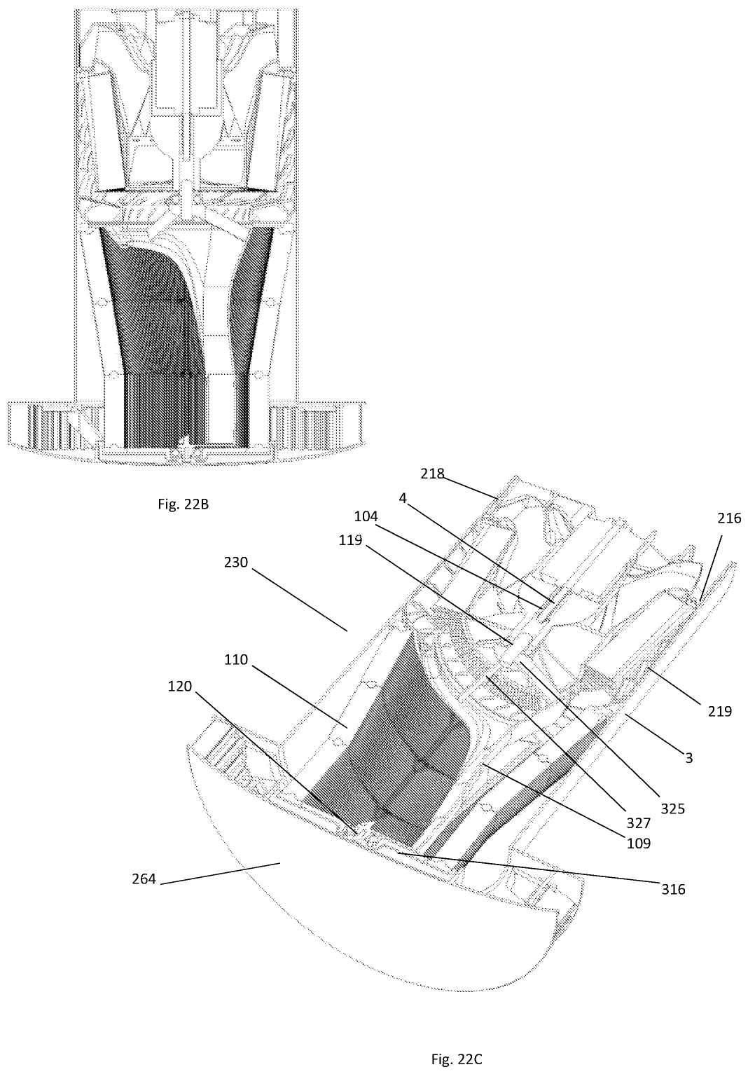

FIG. 20—Heat exchange module, fan unit, and room unit, cross section

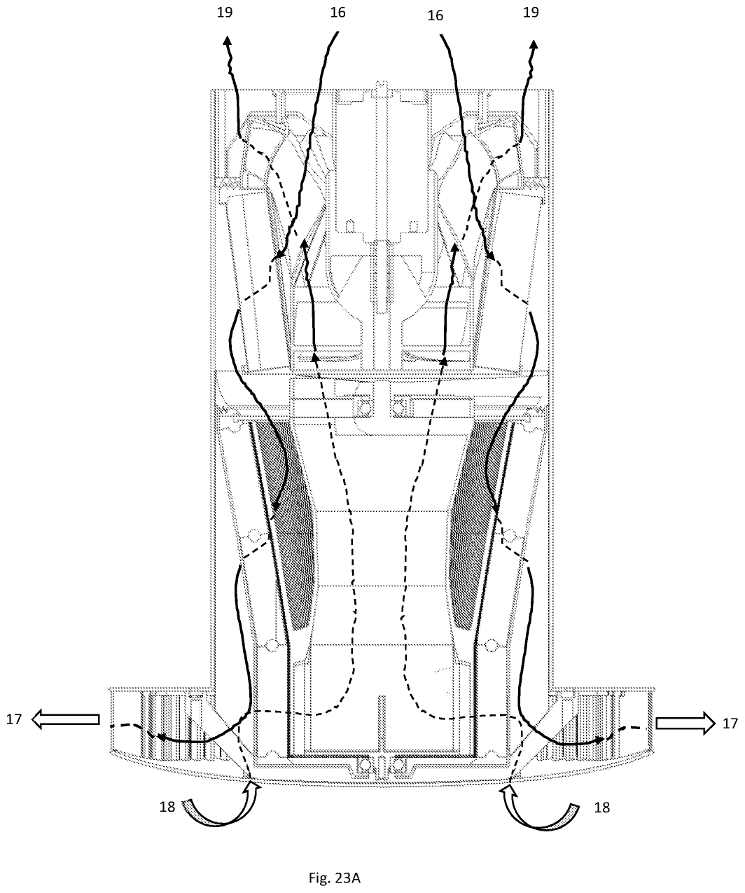

FIG. 21A—Impeller assembly w/rotating filter, from outdoor side view

FIG. 21B—Impeller assembly w/rotating filter and casing, motor and motor fastening means from outdoor side view

FIG. 21C—Impeller assembly w/rotating filter, cross section side view

FIG. 21D—Impeller assembly w/rotating filter, from outdoor side cross section oblique view

FIG. 21E—Impeller assembly w/rotating filter and casing, motor and motor fastening means from indoor side view

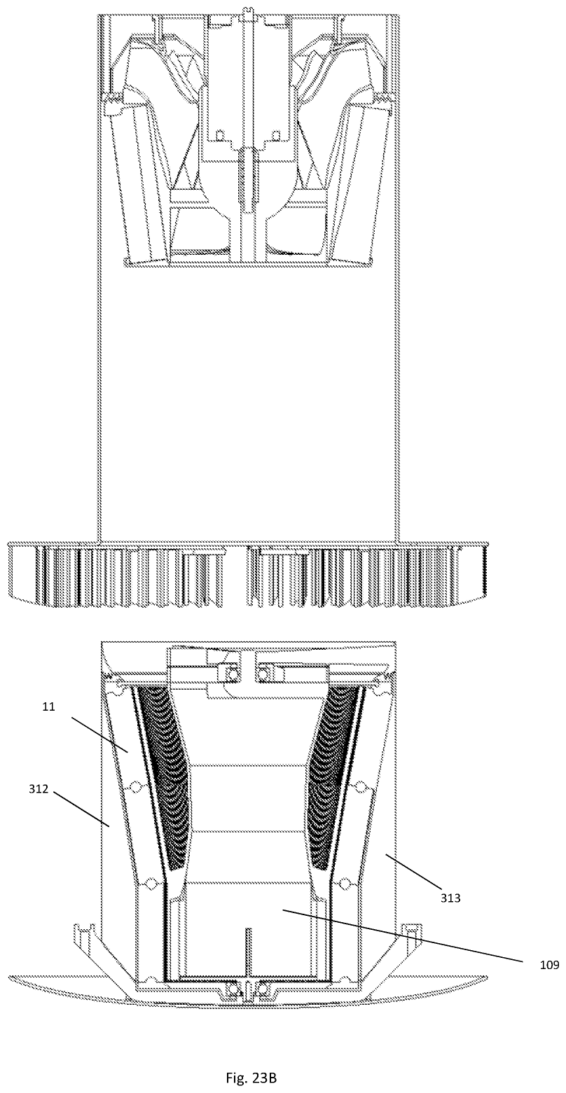

FIG. 22A—Ventilation unit comprising Impeller assembly w/rotating filter, cross section, heat exchange module in an outdrawn position

FIG. 22B—Ventilation unit comprising Impeller assembly w/rotating filter, cross section—side view

FIG. 22C—Ventilation unit comprising Impeller assembly w/rotating filter, cross section—oblique view

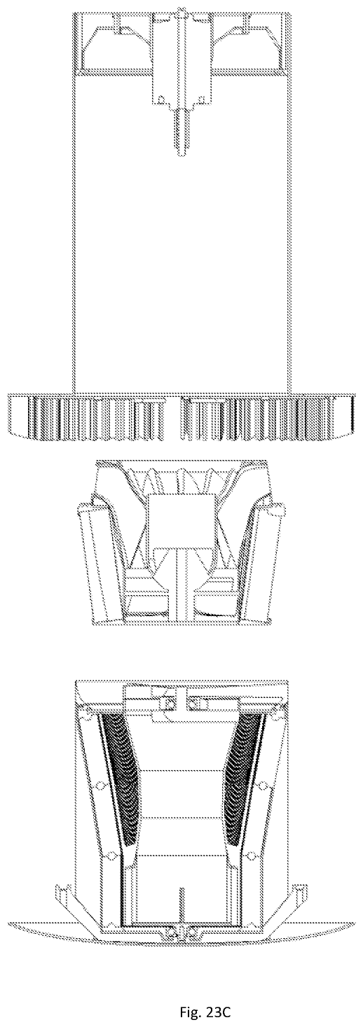

FIG. 23A—Ventilation unit comprising Impeller assembly w/rotating filter, cross section

FIG. 23B—Ventilation unit comprising Impeller assembly w/rotating filter, cross section, Heat exchange module assembly outdrawn

FIG. 23C—Ventilation unit comprising Impeller assembly w/rotating filter, cross section, Heat exchange module assembly and impeller assembly outdrawn

In the following description the use of specific terms shall be interpreted widely and at least in the meaning as defined in the following:

Air/gas flow directions:
Supply air: is defined to be from the fresh air side through the ventilation device.
Exhaust air: Return air going the opposite direction to Supply air through the ventilation device.

Outdoor: is used to define the fresh air side of the ventilation device, whereas the indoor side is the opposite side of the ventilation unit.

Dual mode impeller: Rotating device for pumping supply and exhaust air simultaneously in two opposite directions.

Dual mode fan: Dual mode, or two-way impeller, motor, motor casing and air director.

Air: The device of the invention is primarily adaptable to be used for air ventilation, but the device and system may be used in any type of gaseous environment. When the term “air” is used in this document, it shall be understood to comprise the meaning of any type of gas.

Heat transfer medium: Porous medium with a large temperature gradient that transfer heat between exhaust air and the supply air.

Heat exchange module: Heat transfer medium including components that directs flows of air through heat transfer medium.

Summer module: A static module, substituting the heat exchange module, optionally comprising a large filter.

Filter module: Filter casing and filter for filtering supply air. The filter module may be connected in rotating connection with the heat transfer medium for transferring the angular momentum needed to rotate the heat transfer medium.

Unit casing: Casing adapted to embrace all parts of the ventilation unit.

Motor housing: A rigid housing that serves as a casing for the impeller motor, that may support one end of a center shaft holding the heat transfer medium.

Supply air director: A part of the dual mode fan comprising foils that may support the motor housing, and reduce rotational spin of the supply air flow from the impeller.

Room unit: A unit on the room side of the inner walls comprising a box/housing/chassis, and ducting adapted for optimal throughput of supply air and exhaust air in various embodiments of the ventilation device.

A valve assembly: An air flow restricting feature comprising a plurality of movable restrictors, typically of an elastomer, for dynamic choking of supply and/or exhaust air, a valve motor and a valve gear assembly.

Now the present invention will be described in more detail, with references to the figures where appropriate.

In the following the ventilation device of the present invention will be described as part of a complete air handling system arranged for ventilating a room, the room having a wall construction through which a duct sleeve is provided between the room itself and an outside fresh air environment into which the ventilation device will be arranged. The ventilation device may comprise modules for heat exchange, simultaneous two-way air flows, dual mode fan, valve assembly, air filters, and airflow direction guides, as well as duct sleeve and unit casing. It should be understood that the various modules could be implemented as a whole or in various combinations without deviating from the inventive concept. It shall be the claims that define the protection scope of the invention.

In a first embodiment as illustrated in FIGS. 1 to 8 the ventilation device 1 of the present invention comprises an dual mode fan 200, the dual mode fan 200 comprising a dual mode impeller 2 mounted to a motor shaft 4 via a motor shaft casing 104 receiving a protruding portion of the motor shaft 4, the motor shaft casing 104 being centrally longitudinal positioned in the dual mode impeller 2 and providing a resilient holding force of the received motor shaft 4, wherein the dual mode impeller 2 when rotated by the force of the rotating motor shaft, produce an supply airflow 16, 17 and an exhaust airflow 18, 19. The dual mode impeller 2 may be rotated by an impeller motor 103 arranged inside the ventilation device 1 on the inside side of the impeller 2. The motor is powered by a power source (not shown) connected to the motor by cable and control lines (not shown).

A control unit 105 that may be integrated in a supply air director 107 providing a casing supporting a motor housing 41 on the inside side of the dual mode impeller 2, may comprise integrated circuitry and programs for monitoring sensors, processing and/or communicating sensor data and controlling the dual mode fan. Sensors and electronics may be integrated into any part of the ventilation unit, and may sense one or more physical properties like fan speed, air flow, air pressure, air temperature, noise, vibration, moisture, or other. Control features may be implemented in the control unit 105 to avoid malfunction and optimize efficiency.

In one embodiment of the invention the impeller 2 is designed in a shape as illustrated in detail in FIGS. 1, 2, 5 and 6A/B. When the motor 103 is activated and providing a spin 60 of the impeller 2, a flow of air 16 is sucked to the central area 181 of the outdoor side of the impeller 2 into a set of supply air channels 61. The supply channels of the impeller works in a turbine like manner, gaining pressure when air is transported through the radial acceleration field and exiting through an outer orbital ring area 182 of the indoor side of the impeller 2. The supply air will thus have acquired rotational forces when exiting the impeller 2.

After entrance the supply air channels 61 split to occupy just a portion of the cross sectional area giving room to the exhaust air channels 62 crossflowing in-between the supply channels 62. The walls of the supply channels 61 are shaped to simultaneously provide the walls of the aerodynamic exhaust channels 62. The exhaust channels 62 transport exhaust from an inner central part 102 of the indoor side of the dual mode impeller 2 to the outer orbital area 184 of the outdoor side of the dual mode impeller 2. Thus the dual mode impeller 2 drives airflow simultaneously in two directions, from outdoor side 16 to indoor side 17 , and from indoor side 18 to outdoor side 19.

FIG. 6D illustrates schematically how the air flows flow into and out of the impeller on the outdoor side above the horizontal line and on the indoor side below the horizontal line.

There are typically 12 separate channels in each direction, but other design may be provided with fewer or more channels.

Looking now at a first embodiment of the ventilation device 1 from outdoor side towards indoor side, the supply air flow flows from the dual mode impeller unit through an air director unit 107 comprising foils 106. The foils 106 of the air director 107 is provided for stopping most of the rotational forces of the supply air which results from the rotation of the dual mode impeller 2. The foils 106 may be arranged to provide two or more entrance heights h1, h2 to reduce the surfing effect that occurs when encountering boundary layers at “low angle” approach. The air director 107 is arranged with an orbital flow-through path peripheral outside of a central duct 111 wherein the motor housing 41 is arranged. The air director unit 107 is further providing a supporting structure forming fastening and compartment for optional printed circuit board(s) 105 and for fastening of the motor housing 41, the motor housing having a center portion 177 on its indoor side for providing a connecting point for a fixed center duct structure 109, 112. The supporting structure of the air director unit 107 may also comprise an outer circular wall 113 having an outer diameter corresponding to the inner diameter of the unit casing 3, such that when the supporting structure of the air director unit 107 is arranged in the unit casing 3, it will provide a fixed support for a motor and provide air labyrinth seals for the rotating parts of the ventilation unit 1. The dual mode impeller 2 is one such rotating part, and a first air labyrinth seal 114 is provided at an interface between the outer wall of the dual mode impeller 2 in the region being at the indoor side of the impeller 2 and the inside of the outer circular wall 113 in the region being at the outdoor side of the outer circular wall 113. A second air labyrinth seal 115 or sealing gliding surfaces is provided between the outer orbital ring area 182 of the indoor side of the dual mode impeller 2 and the inner central part 102 of the indoor side of the dual mode impeller 2, which will be in sealing interaction with a corresponding orbital area 123 of the supporting structure. The second air labyrinth seal 115 will further provide an air tight seal between the airflows flowing through the dual mode impeller 2 simultaneously in different directions.

On the indoor side of the air director unit 107 an air filter unit 300 is arranged providing an orbital compartment for the supply air flow 321, and a central duct for the exhaust air flow 322. The orbital compartment for the supply air flow 321 having an inner enclosing wall 302, and an outer enclosing wall 301, the orbital compartment being provided for receiving an air filter 108, and provide an longitudinal supply air flow 321 path with air tight sealing 116, 117, 118 through the air filter and towards the central duct for the exhaust air flow 322. The air filter 108, which extends in a generally perpendicular direction to the longitudinal direction, may be provided with an inner and outer wall structure having sufficient sealing properties to make either one or both of the inner enclosing wall 302, and an outer enclosing wall 301 of the air filter unit 300 superfluous, and thus can be dropped in the design of the filter unit 300. The filter unit 300 may further be fixedly connected to the heat exchange module 110. The air filter unit 300 further provides a filter unit hub 306 providing passage and arrangement for a motor side ball bearing 119 connection 304 to center duct hub 325 of the center duct structure 109. The motor side ball bearing 119 connection 304 facilitates easy rotation of the air filter unit 300 and the heat exchange module 110. The center duct hub 325 being fixedly held by centering spokes 327 to an inside of a center duct collar 328 of the center duct structure 109. The center duct collar 328 defines a pipe duct portion of the center duct structure 109 defining a duct for the exhaust air flow 322 towards the central duct of the air filter unit 300. The air filter unit 300 and the heat exchange module 110 is further rotationally hinged in an indoor side ball bearing 120 arrange in a center opening 310 of a bottom wall 121 of the heat exchange module 110. The air speed together with rest rotational forces in the airflow in the outdoor side of the filter unit 300, causes the heat exchange module 110 and filter module 300 to rotate around its own longitudinal center axis 166. Sensors detecting (not shown) rotation speed of the heat exchange module 110 and filter module 300 may be provided. Further breaking means (not shown), for controlling rotation speed of the heat exchange module 110 and filter module 300 may also be provided.

In the opposite side of the center duct structure 109, at the indoor side, a further center duct hub 168 being fixedly held by centering spokes 169 to the inside of the center duct structure 109. The further center duct hub 168 having a protruding portion on its indoor side, the protruding portion is provided to be arranged through the center opening 310 of a bottom wall 121 of the heat exchange module 110 and a distant end 167 of the protruding portion having a form corresponding to a static endcap 316 center hole/recess 317 into which it is to be arranged, thereby holding the center duct structure in a static position in all operation modes. The static endcap 316 being provided at the indoor end side of the ventilation unit. Typically the distant end 167 form and corresponding center hole/recess 317 is formed in a torqs male and female contact form respectively. Other connecting forms or mechanisms may be chosen without deviating from the inventive concept.

For further stability, a center axle may be provided running from the motor side ball bearing 119 center to the indoor side ball bearing 120 center arrange in the center of a bottom wall 121.

The heat exchange module 110 is typically formed as a cone providing an inner side and an outer side, the cone form may be widest, having the largest diameter, towards the outdoor side and tapering towards a smaller diameter towards the indoor side of the ventilation unit 1. Having this form provide a path for the supply air 16, 17 to flow into the heat exchange module 110 cone from the inside and towards the outside, whilst exhaust air flow 18, 19 flow the opposite way. Other forms may be provided, for example if the cone form of the heat exchange module was turned the opposite direction with its widest end toward the indoor side of the ventilation unit, the supply air 16, 17 would flow through the heat exchange module 110 cone from the inside to the outside, and the exhaust air flow 18, 19 from the outside to the inside.

The heat exchange module 110 cone is free to rotate around its center axis, rotating a thermal mass of the heat exchange medium, between the supply and exhaust air flow paths. Lamellas in the heat exchange module 110 cone may be constructed of any type of low thermal conductivity material, like a plastic compound, wood, cardboard, ceramics or others. The low thermal conductivity material of the heat exchange module 110 may be in the form of lamellas, porous molded material, or other, but in the following lamellas is used as a common term, not excluding any form or material fulfilling the required heat exchange characteristics.

The lamellas have during operation a temperature gradient that provides a high thermal efficiency of the heat exchanger.

The center duct structure 109 is formed such that it leads the supply air flow from the filter 108 from the inside of and towards a first longitudinal half portion of the heat exchange module 110. The center duct structure 109 divides the inner volume of the heat exchange module 110 in two longitudinal halves, and is provided with longitudinal tight fitting center duct knives 307, 308 corresponding to the inside longitudinal form of the heat exchange module 110 which effectively divides the space of the exchange module 110 inside in the two halves and prevents air flow leakage between supply and exhaust air flows flowing in opposite directions inside the heat exchange module 110. The center duct structure 109 is formed as a longitudinal half of a pipe in the indoor portion of the center duct structure 109, the indoor portion typically being at least half the length of the center duct structure 109. At the outdoor portion of the center duct structure 109 the half pipe form grows to comprise a full pipe form of the center duct collar 328 corresponding to the central duct of the filter module. At the outdoor side of the center duct structure 109 on the opposite longitudinal half of the pipe in the indoor portion of the center duct structure 109, an encircling collector channel 320 having its outer diameter corresponding to the diameter of outer enclosing wall 301 of the air filter unit 300 and its inner diameter defined by the center duct collar 328 is provided. The collector channel 320 provides for collecting supply air from the whole orbital interface towards the filter 108 and leading it to the longitudinal half defined by the outside of the longitudinal half of a pipe in the indoor portion of the center duct structure 109 limited on its side by the center duct knives 307, 308.

The center duct knives 307, 308, the inside of the longitudinal half of a pipe in the indoor portion of the center duct structure 109, and the underside of the encircling collector channel 320 provides a channeling path for the exhaust air flow from the inside of the longitudinal half of a pipe in the indoor portion of the center duct structure 109 through the inside of the center duct collar 328 and towards the central duct for the exhaust air flow 322 in the air filter unit 300.

The center duct structure 109 leads the exhaust air as it flows from the indoor side of and through the second longitudinal half portion of the heat exchange module 110 towards the center portion of the air filter module 300. The center duct knives 307, 308 ensures by being tightly fitted towards the inside of the heat exchange module 110 minimal air flow exchange between the two longitudinal inner half spaces defined by the center duct structure 109. The tapering form of the heat exchange module 110 is provided to ensure a uniform differential pressure over the lamellas along the longitudinal length of the heat exchange module, securing uniform transversal velocity through the lamellas, which in turn optimizes the efficiency.

The supply air filter 108 in the filter module 300 may be of any form, doughnut, cylindrical orbit, coned, flat, bellow shaped, porous, and other. If sealing longitudinal outer and inner walls are not provided in the filter, this is provided by inner enclosing wall 302, and an outer enclosing wall 301 of the air filter unit 300 itself.

When supply air flow leaves the supply air director it is lead through a rotating low resistance air filter 108 before the air stream is led by the static center duct structure 109 leading the air from the filter to a first half side of a rotating heat exchange module 110. The filter 108 and the heat exchange cone 110 may be rotationally connected, and rotates around its own central longitudinal axis by a rest rotational force of the supply air flow still present after the air stream has left the supply air director foils 106.

On the indoor side of the rotating heat exchange module 110, a sleeve air guide assembly 330 is provided comprising static outside flow separator knives 312, 313 having an inward profile corresponding to the tapering outer form of the rotating heat exchange module 110, and an outward profile corresponding to the inside of the unit casing 3. The static outside flow separator knives 312, 313 divides the room between the outside of the rotating heat exchange module 110 and the inside of the unit casing 3 in the region of the rotating heat exchange module 110 in two longitudinal halves, one half which provides a channel for the supply air flow, and the other half which provides a channel for the exhaust air flow in the opposite direction. The static position of the static outside flow separator knives 312, 313 corresponds to the static position of the longitudinal tight fitting center duct knives 307, 308. The effect of these longitudinal knives 307, 308, 312, 313 is such that when the rotating heat exchange module 110 slowly rotates, the flow of air through the rotating heat exchange module 110 is guided in one longitudinal half of the rotating heat exchange module 110 statically defined by the position of the longitudinal static outside flow separator knives 312, 313 and the longitudinal tight fitting center duct knives 307, 308 in a first direction, and through the opposite longitudinal half of the heat exchange module 110 in the other direction. The rotation of the longitudinal heat exchange module 110 will result in heat exchange between the air streams flowing in each direction. In the case when indoor temperature is higher than outdoor temperature, the exhaust air will warm up the rotating heat exchange module in the longitudinal half area defined by tight fitting center duct knives 307, 308, and as the heated area of the heat exchange module 110 rotates and enters the opposite side defined by tight fitting center duct knives 307, 308 the supply air will be heated by the higher temperature of the heat exchange module 110.

On the indoor side of the sleeve air guide assembly, a number of encircling air direction foils 314 are provided to achieve an even distribution to and from the room unit on the indoor side. The endcap 316 is provided for bearing and holding of the rotating heat exchange module 110 when assembled. The center hole 317 is provided for holding the static central duct structure 109 by receiving its protruding member 167, and the base of the protruding member 167 may form the center for the indoor side ball bearing 120. The sleeve air guide assembly 330 may comprise one or more encircling foil support rings 311 towards the outdoor end of the sleeve air guide assembly 330 to ensure correct and stable positioning of the longitudinal static outside flow separator knives 312, 313.

Experiments indicate that the rotating heat exchange module 110 eliminates condensation problems under almost every condition.

In a further embodiment of the present invention an air filter may be attached to the indoor side of the impeller as illustrated in FIGS. 21A-E and 22A-C. In this embodiment both the impeller 210 and filter 211 is arranged connected together in a rotating relationship. Extending from the indoor side of the impeller is a circular impeller duct 213 with an inner diameter adapted to fit the outer diameter 214 of the exhaust inflow of the impeller. An exhaust air spin element 232 comprising a plurality of propeller blades/foils that are attached on their inner side to and equally orbital spaced apart around a central portion 231 of the impeller structure, the central portion 231 stretching longitudinally towards the indoor side, the propeller blades pointing outwards from the central portion 231 towards and optionally attached on their outer side to the inside of the circular impeller duct 213 and the propeller blades are curved towards the impeller exhaust inlet such that when impeller rotate aid to put rotation on exhaust air before being directed towards and into the spinning impeller. This reduce noise and resistance to the exhaust air 18, 19 flow.

The filter 211 is pipe formed, preferable formed as a cone, and attached to the outside of the impeller 210 and impeller duct 213 in the longitudinal direction spanning over the supply air outlet channels of the impeller 210 and the impeller duct 213 in a manner such that when supply air 16, 17 flows out of the impeller 210 it flows towards the inside of a first portion of the longitudinal oriented pipe formed filter 211. A second portion of the pipe formed filter 211 spans over the outside of the circular impeller duct 213. The coned form of the pipe formed filter 211 has its larger inside diameter at the impeller side. The lower inside diameter of the coned form filter 211 of the corresponds to the outside diameter of the circular impeller duct 213, and the narrow end of the pipe formed filter 211 fits in a closed manner over the impeller duct 213 such that when that supply air 16, 17 is distributed along the inside of the pipe formed filter 211, all air is pushed through the filter in a generally perpendicular to the longitudinal direction supply air flow path 224 through the air filter 211. The pipe formed filter 211 rotates with the impeller 210. Inside distance members (not shown) may be arranged outside the impeller duct to ensure sufficient room for the supply air 16, 17 to reach the whole longitudinal inside surface of the pipe formed filter 211. These distance members may be omitted as the air pressure from a spinning impeller 210 may sufficiently push the pipe formed filter 211 outwards to allow sufficient room for distribution of the supply air 16, 17 flow along the inside surface of the filter. The impeller may in this embodiment comprise a protruding flange 215 formed as a base on its indoor facing side for receiving the outdoor end of the pipe formed filter 211. An outer portion of the outdoor facing side of the protruding flange 215 comprise an air labyrinth seal or sealing gliding surface, the seal operates in an engaging manner with a corresponding static seal formed flange 216 being fixedly attached to a impeller unit casing 218. The static seal formed flange 216 defining the level at which the assembly of the impeller 210, the coned formed filter 211 and the impeller duct 213 is arranged in the impeller unit casing 218 and a filter casing 219.

The supply air 16, 17 flows/are thrown outwards and through the pipe formed filter 211 when the impeller 210 and pipe formed filter 211 is rotating. Outside the pipe formed filter 211, a portion of the static filter casing 219 may comprise on its inside, between the static seal formed flange 216 and an air director unit 220, threads like auger members 221 that defines a space and path for the supply air to exit the outside surface of the pipe formed filter 211 and flow towards the air director unit 220. The air director unit 220 comprise an air director inner ring 222, wherein the air director inner ring 222 diameter is comparable to the impeller duct 213 inside pointing diameter 223. An impeller inner duct air seal (not shown) is provided between the air director inner ring 222 and the impeller duct 213 inside pointing diameter 223. The impeller inner duct air seal (not shown) prevents supply air path 16, 17 to be isolated from the exhaust air path 18, 19. The threads like auger members 221 provides for the air to be directed downstream towards the indoor side in a controlled spiral path, wherein the threads like auger members 221 also reduces the tunnel effect.

The impeller 210, the impeller duct 213 and the pipe formed filter 211 are connected, and will when motor 103 is activated rotate together. The motor is encompassed in an impeller motor housing 212 arranged in the center of the impeller 210, the impeller motor housing 212 may be an integrated central portion of the impeller 210, further providing an opening towards the outdoor side such that a motor 103 being fixedly attached to the static impeller unit casing 218 enters the impeller motor housing 212 from the outdoor side. The impeller 210, the impeller duct 213 and the pipe formed circular filter 211 may be dismounted by pulling it out of the static impeller unit casing 218 on the indoor side of the ventilation unit 230. The pipe formed circular filter 211 may then be removed by pulling it off the impeller 210 and impeller duct 213. The impeller 210 may be cleaned and a new pipe formed circular filter 211 can be attached around the impeller duct 213 before the assembly of the impeller210, the impeller duct 213 and the pipe formed circular filter 211 is mounted in the static impeller unit casing 218 by pushing it into the static impeller unit casing 218 until the air labyrinth seal or sealing gliding surface of the protruding flange 215 connects to the static seal formed flange 216 being fixedly attached to the static impeller unit casing 218, and the impeller 210 connects to the motor 103.

The static filter casing 219 the air director unit 220 may be formed in one piece, and at least the static filter casing 219 is provide with an outer diameter dimensioned to closely fit inside the unit casing 3 in a retaining manner when pushed inside the unit casing 3.

One embodiment of the ventilation unit 230 will then be assembled as illustrated in the cross section FIG. 22C wherein an indoor cover 264 and the unit casing 3 provides holding support for the ventilation assembly comprising the rotating heat exchange module 110 and the fixed center duct structure 109 being connected to a static end cap 316 via the an indoor side ball bearing 120. The an indoor side ball bearing 120 also providing a rotating connection point for the rotating heat exchange module 110. On teh outdoor side of the fixed center duct structure 109 a center duct hub 325 being fixedly held by centering spokes 327 connected in the far outdoor side of the fixed center duct structure 109 provides for a motor side ball bearing 119. The motor side ball bearing 119 further provides for rotating connection holding the impeller assembly with impeller 210 and pipe formed rotating filter 211 in place pushing it towards the static seal formed flange 216 being fixedly attached to a impeller unit casing 218. A retaining center recess of the impeller comprising an axle casing 104 for receiving the motor shaft 4 provides the rotation connection between the motor and the impeller assembly, and when mounting the impeller assembly the axle casing 104 may be designed to provide a resilient spring force holding the motor axle 4. Other connecting mechanisms may be provided, such as but not limited to male-female formed protrusion and recess, bolt and nut connection, click connectors, splint fixation of axle in center duct of impeller assembly or other.

A further embodiment of the ventilation unit is illustrated in FIG, 23A-C wherein the heat exchange module is shown outdrawn in FIG. 23B and further the impeller and rotating filter is outdrawn in FIG. 23C. The path of supply air 16, 17 and exhaust air flow 18, 19 is ilustrated in FIG. 23A.

The ventilation unit 1 may in a further embodiment be adapted to provide maximum ventilation effect/air flow. In such a case the rotating heat exchange module 110, room unit and filter unit 300 may be substituted with a static module 190, room module and optional filter, hereafter called a summer module, as illustrated in FIG. 19A-C. The summer module is primarily for use when heat is not required to be exchanged, and filtering and/or high air flow for transport of excessive heat is of more importance. The summer module 190 is arranged in the unit casing 3 on the indoor side of the dual mode fan 200. The summer module 190 comprise an inner central duct 193 and an orbital longitudinal duct 194 defined by the outside surface of the wall of the inner central duct 193 and the inside surface of the unit casing 3. The summer module 190 provides a direct path for the exhaust air flow from the indoor side of the ventilation unit 1 through the inner central duct 193 and into the inner central part 102 of the indoor side of the dual mode impeller 2 in the dual mode fan 200. In the opposite direction it channels the supply air directly from the outer orbital ring area 182 of the indoor side of the impeller 2 in the dual mode fan 200 through the orbital longitudinal duct 194 to the indoor side of the ventilation unit 1.

The summer module 190 may further be provided with a pollen/smog filter 192, for filtering of the supply air, arranged in the path of the supply air 16,17. The pollen/smog filter 192 may be formed in a cone form having the wider circumference in the indoor side of the pollen/smog filter 192, and arranged in the orbital longitudinal duct 194 defined by the outside surface of the wall of the inner central duct 193 and the inside surface of the unit casing 3. The pollen/smog filter 192 inside diameter in the narrow end which will be closest to the dual mode fan 200, has an inside circumference corresponding to the outside diameter of the inner central duct 193, and thus no supply air can slip through on the inside of the pollen/smog filter 192. In the other end the outside diameter of the widest part of the pollen/smog filter 192 close to the indoor side of the ventilation unit corresponds to the inside diameter of the unit casing 3, and thus no supply air can slip pass the filter on the outside without going through it before entering the room unit of the ventilation unit 1. In this manner the supply air must pass through the pollen/smog filter 192 when flowing from the dual mode fan 200 to the indoor side of the ventilation unit 1. Filtering properties may be adapted to requirements for throughput and degree of pollen and pollution.

In one embodiment of the present invention the rotating heat exchange module 110 and room unit in the first embodiment is provided as an exchangeable assembly, that easily can be exchanged with a static summer module 190 and a second embodiment of a room unit comprising an optional pollen/smog filter 192. This makes the unit a powerful air cleaner as well as an effective cooling device in warm climates/seasons.

A room unit comprising a peripheral encircling flow guide 260, 263 and an indoor cover 122, 264 terminates the indoor side of ventilation unit 1 wherein the flow guide may be defined by an assembly able to partially restrict airflow in one or both directions.

In one embodiment of the room unit, as defined in FIG. 20, the air flow is guided by a plurality of foils 263 arranged perpendicular to the air flow in a peripheral orbital ring between the indoor cover 264 and an encircling base 265. When the room unit is arranged on the ventilation unit 1 comprising a rotating heat exchange module 110 and longitudinal static outside flow separator knives 312, 313, the supply air will blow out between the foils 263 at one half of the peripheral orbital ring between the indoor cover 264 and an encircling base 265, and exhaust air will be sucked in in the opposite half. The foils may be rotationally hinged on one side 266, 267, and connected to a foil rotation means (not shown) on the opposite side 266, 267, and thus be rotatable to place more foil area into the air flow and thus restrict the air flow in either flow direction. The rotation means may be driven by one or more small electrical motors arranged in the room unit so that both flows can be choked independently. Thus for example 4 modes may be provided: low supply air flow/low exhaust air flow, low supply air flow/high exhaust air flow, high supply air flow/low exhaust air flow, and high supply air flow/ high exhaust air flow. Fewer modes may be used, and more providing intermediate positions to be selectable. It is then possible bot to provide vacuum, equilibrium or overpressure conditions on the indoor side of the ventilation unit. This enables balancing the unit to achieve maximum efficiency during varying differential pressure.

In one scenario example can a “sleeping mode” ensure that ventilation by the ventilation unit is kept at a minimum. For instance bed rooms during the day. In order to avoid severe leakage of hot air on windy days, both supply and exhaust air flows may be choked to a maximum.

In a further scenario where individual choking is required may be during pollen season using the summer module. In windy days the chokes may be set to deliver an overpressure to the indoor side, wherein the supply air comprising clean pollen free air is pushed into the house, thereby maintaining the overpressure inside the house and prevent leakage of pollen through small gaps and cracks into the house.

In a second embodiment of the room unit for use with a static summer module 190, as defined in FIG. 19A-C, the supply air flow 16, 17 flows from the orbital longitudinal duct 194 defined by the outside surface of the wall of the inner central duct 193 and the inside surface of the unit casing 3, through the optional pollen/smog filter 192 and exits the ventilation unit 1 guided by a plurality of house unit foils 263 arranged perpendicular to the air flow in a peripheral orbital ring between an inflow cover 195 and an encircling base 265. The encircling base 265 may be omitted by using the room wall itself as a channeling surface. The inflow cover 195 is formed as an outwards bending flange being connected to the indoor end of the inner central duct 193 in one end and extends outwards in diameter to provide guiding of the supply air through the house unit foils 263. The house unit foils 263 may be rotationally hinged on one side 266, 267, and connected to a foil rotation means (not shown) on the opposite side 266, 267, and thus be rotatable to place more foil area into the air flow and thus restrict the supply air flow. The rotation means may be driven by one or more small electrical motors arranged in the room unit. Exhaust air 18, 19 is guided into the room unit by a circular room unit exhaust duct 196 defined by the outside surface of the inflow cover 195 and the inside surface of the exhaust cover 191. The exhaust cover 191 may advantageously be formed with a concave form mirroring the curving of the inflow cover 195, such that when the exhaust air flow flows through the circular room unit exhaust duct 196 and into the inner central duct 193 the exhaust air flow have little turbulence. Further house unit foils (not shown) may be arranged in the path of the exhaust air flow in the circular room unit exhaust duct 196, these foils may also be rotationally hinged and connected to a foil rotation means (not shown) as described above.

The room unit flow guide 260 may in a further embodiment as shown in FIGS. 1, 4, 5, 7 and 8 comprise a perforated 261 surface through which the airflow must pass. The flow guide 260 may additional have a dynamically modifiable restriction capability. This may be achieved by adding a second movable perforated film 262 to the flow guide 260. By adding controlling means such as a stepper motor connected to the second movable perforated film 262 it is possible to slide the perforations of the second movable perforated film 262 across the perforations 261 of the flow guide 260, and hence alter the flow resistance through the flow guide 260. The air flow is directed towards the indoor side on one half side of the flow restrictor and in the opposite direction on the other half side. The flow may be restricted in one of or both half sides of the flow guide 260, and such enable the ventilation unit 1 to provide pressurized or vacuum effect on the indoor side of the ventilation unit 1.

It is acknowledged that although the room units plays a role in optimized operation of the ventilation unit of the present invention, it is possible to provide any of the embodiments of the room units described above as a standalone device for implementation of other ventilation unit types.

The ventilation unit 1 is in one embodiment installed in a wall between an out-door environment and an inside room. The wall typically comprises a through channel with a cross section corresponding to the outer cross section of the unit casing 3 including tolerances. The cross section form may be uniform through the whole wall depth (wall thickness), as may be the case with the ventilation unit. The ventilation unit may have a cylindrical outer form. A duct sleeve (not shown) may be provided to be installed in the through channel in the wall. The duct sleeve internal form may correspond to the outer form of the ventilation unit 1 and its additional cabling and optional sensor connections. The duct sleeve may have through holes for power and optional control signal cabling and connectors being adapted to connect to cabling provided in the ventilation unit for powering of motors, sensors and electronics comprised in the ventilation unit 1. The connectors and form may be such that the ventilation unit 1 can be slid into the duct sleeve and a snap latch lock may hold it in place and be fully operational. Other locking mechanisms may be used to provide both for continuous operation mode and for embodiments where change between heat exchange mode and summer mode assemblies is enabled.

A ventilation unit 1 is installed such that the impeller side is directed towards the outdoor side environment in a manner such that the impeller can run freely. Optional is mounting of an impeller protection cover outside the impeller, wherein the impeller protection cover also may provide channeling and separation of the air streams going into 16 and being pushed out 19 of the impeller 2.

In a third embodiment of the ventilation unit 1 a further extender duct and further air direction module as illustrated in the FIGS. 15, 16, 17 and 18 is provided for enabling installation of the ventilation unit 1 in thicker walls. Thus in such walls the impeller 2 will in a standard length version be arranged some way into the wall seen from the outside. The extender provides an inner central extender duct 180 for leading the supply air 16 from outdoor side of the ventilation unit to the impeller 2, and a concentric outer duct 181 around the inner central extender duct 180 for leading exhaust air 19 from the impeller to the outdoor side of the ventilation unit 1. For longer extender ducts it may be advantageous to provide a further air direction module 160 for stopping the air spin of the exhaust air 19 exiting from the impeller 2 towards the outdoor side of the ventilation unit 1. An air labyrinth seal 170 is provided on an orbital flange 171 that separates the inflow channels from the outflow channels of the impeller 2 on the outdoor side, connecting to the inner portion 161 of a concentric inner flange of the further air direction module 160. Likewise the circular inner portion 182 of the inner central extender duct 180 is arranged in a sealing manner to the outer portion 162 of the concentric inner flange of the further air direction module 160, such that supply air flowing in the inner central extender duct 180 does not leak to the exhaust air flow flowing in the opposite direction through the concentric outer duct 183 around the inner central extender duct 180 leading exhaust air 19 from the impeller to the outside.

A further embodiment of the heat exchange module and filter module (not shown) may be provided with a fixed filter module, non-rotating, and a motor driven rotating heat exchange module. Heat exchange module may be driven by a geared axle connected to the impeller motor, or by a separate motor used solely for rotating the heat exchange module.

The dual mode fan may in a further embodiment of the invention be combined with a counter flow heat exchanger, standalone as a mobile device or installed in a wall duct providing an optimized unit for drying out rooms having a moisture and/or radon problem, such as in cellars. In such an environment neither heat exchange or air filtering is of importance, and the task is to shift sufficient volume of air out of the indoor side room of the air flow. Exhaust air must be transported outside, and dry air must be supplied. Thus a typical counterflow unit with draining capacity may be connected in series with the fan unit.

The ventilation unit embodiments either as defined above or where any number of features from the above described embodiments are individually combined, may be provided with wired or wireless communication means which enables a communication contact with a provided remote monitoring and control system. This remote monitoring and control system may comprise a cloud service, applications/apps provided for standalone handheld computers such as laptop, tab, smartphone or other, communication means and analysis programs. Thus monitoring and controlling of ventilation characteristics may be provided as a service or user defined from a remote controller. Sensors and motors in the ventilation unit may be controlled remotely.

Two or more ventilation units may be in communication contact via the communication means comprised in the ventilation unit or via the remote monitoring and control system. Sensor may additionally be installed in the environment on the indoor side of the ventilation units and being in contact with the control unit 105 in the ventilation units and/or the remote monitoring and control system to provide further flexible controlling feature of a ventilation system.

The invention may further be provided in a first device embodiment of a dual mode impeller assembly for use in a room ventilation unit comprising a dual mode impeller 2, 210 and a motor 103 for providing the spinning force to the dual mode impeller 2, 210, wherein the dual mode impeller 2, 210 has a cylinder shape for rotating around its longitudinal center axis 166, the dual mode impeller comprising a plurality of supply air channels 61 and exhaust air channels 62, wherein when the dual mode impeller 2, 210 is rotated the supply air channels 61 propels supply air 16, 17 from, and into, a central portion 181 of a first side of the dual mode impeller 2, 210 towards, and out of, an outer orbital portion 182 of a second side of the dual mode impeller 2, 210, and the exhaust air channels leads exhaust air 18, 19 in the opposite direction from, and into, a central portion 102 of the second side of the dual mode impeller 2, 210 and towards, and out of, an outer orbital ring area 184 on the first side of the dual mode impeller 2, 210, the supply air channels walls are designed such that they form parts of the walls of the exhaust air channels 62 crossflowing in-between the supply air channels 61.

A second dual mode impeller assembly according to the first device embodiment, further comprising an circular formed air filter 108, 211 arranged on the second side of the dual mode impeller 2, 210, the circular formed air filter 108, 211 having a first side facing towards the dual mode impeller for receiving the supply air 16, 17 that flows out of the outer orbital portion 182 of the second side of the dual mode impeller 2, 210.

A third dual mode impeller assembly according to the first or second device embodiment, wherein a longitudinal central duct 111, 213 is provided for separating supply air 16, 17 on its outside and exhaust air 18, 19 on its inside at the second side of the dual mode impeller 2, 210, wherein a first portion of the longitudinal central duct 111, 213 is provided with a diameter adapted to correspond to the diameter of the central portion 102, 214 of the second side of the dual mode impeller 2, 210, and the longitudinal central duct 111, 213 is arranged in a sealing manner to the dual mode impeller 2, 210 such that little or no air between supply air flow 16, 17 and exhaust air flow 18, 19 can be mixed, and wherein at least a portion of the circular formed air filter 108, 211 is arranged over and outside the longitudinal central duct 111, 213.

A fourth dual mode impeller assembly according to any of the first to third device embodiment, further comprising a circular formed static air director 107, 220 arranged in the supply air flow 16, 17 path on the second side of the dual mode impeller 2, 210, the circular formed static air director 107, 220 comprising foils arranged within an orbital flow-through path peripheral outside of a central duct 111, 222, he foils of the air director 107, 220 is provided for stopping most of the rotational forces of the supply air which results from the rotation of the dual mode impeller 2, 220.

A fifth dual mode impeller assembly according to the fourth device embodiment, wherein the foils are provided with two or more entrance heights h1, h2 to reduce the surfing effect that occurs when encountering boundary layers at “low angle” approach.

A sixth dual mode impeller assembly according to the first device embodiment, wherein the dual mode impeller further comprise a centrally longitudinal arranged motor shaft casing 104 with a central recess for receiving and holding a portion of a motor shaft 4.

A seventh dual mode impeller assembly according to the sixth device embodiment, wherein the motor shaft casing 104 comprise one of a resilient material, male-female formed protrusion and recess, bolt and nut connection, click connectors, or splint fixation of axle in center duct of impeller assembly for providing a holding force on the received motor shaft 4.

An eighth dual mode impeller assembly according to any of the first to seventh device embodiment, further comprising a heat exchange module 110 arranged in a longitudinal direction on the second side of the impeller, the heat exchange module 110 is arranged to spin around a half pipe formed center duct structure 109, the heat exchange module 110 further comprising an encircling collector channel 320 for receiving all supply air 16, 17 flowing from the outer orbital portion 182 of the second side of the dual mode impeller 2, 210 leading it to and through one longitudinal half of the heat exchange module 100, and exhaust air 18, 19 flow through the other longitudinal half of the heat exchange module 110, the center duct structure 109 being provided with a half pipe structure to separate the air flows inside the heat exchange module 110 in two longitudinal halves, and the center duct structure 109 further on its sides having center duct knives 307, 308 extending outward on either side, the center duct knives 307, 308 having its radially peripheral end form adapted to the curvature of the inside of the heat exchange module 110, and the dual mode impeller assembly further comprising a sleeve air guide assembly 330 comprising static outside flow separator knives 312, 313 having an inward profile corresponding to the tapering outer form of the rotating heat exchange module 110, and an outward profile corresponding to the inside of a unit casing 3, the center duct knives 307, 308 and the static outside flow separator knives 312, 313 being arranged longitudinally aligned pair wise on the inside and outside of the heat exchange module.

A ninth dual mode impeller assembly according to any of the second to eighth device embodiment, wherein the dual mode impeller 2, 210 and the circular formed air filter 211 is arranged connected together in a rotating relationship, wherein the circular formed air filter 211 is pipe formed and extends in a generally longitudinal direction over a portion of the second side of the dual mode impeller 2, 210 and a portion of the longitudinal central duct 213, and providing a generally perpendicular to the longitudinal direction supply air flow path 224 through the air filter 211.

A tenth dual mode impeller assembly according to any of the second to eighth device embodiment, wherein the heat exchange module 110 and the circular formed air filter 108, 211 is arranged connected together in a rotating relationship, wherein the circular formed air filter 108, 211 extends in a generally perpendicular direction to the longitudinal direction, and providing a longitudinal supply air flow 321 path through the air filter 108.

A first ventilation unit embodiment comprising dual mode impeller assembly according to any one of the first to tenth device embodiment, further comprising a peripheral encircling flow guide 260, 263 and an indoor cover 122, 264 for termination of the indoor side of the ventilation unit.

A second ventilation unit according to first ventilation unit embodiment, wherein the flow guide 260, 263 may be defined by an assembly able to partially restrict airflow in one or both directions.

1. A dual mode impeller assembly for use in a room ventilation unit, comprising:
a dual mode impeller; and
a motor for providing a spinning force to the dual mode impeller,
wherein the dual mode impeller has a cylinder shape for rotating around a longitudinal center axis of the dual mode impeller,
wherein the dual mode impeller comprises a plurality of supply air channels and exhaust air channels,
wherein, when the dual mode impeller is rotated:
the supply air channels propel supply air in a first direction from, and into, a central portion of a first side of the dual mode impeller towards, and out of, an outer orbital portion of a second side of the dual mode impeller, and
the exhaust air channels lead exhaust air in a second direction opposite the first direction from, and into, a central portion of the second side of the dual mode impeller and towards, and out of, an outer orbital ring area on the first side of the dual mode impeller,
wherein walls of the supply air channels form parts of walls of the exhaust air channels crossflowing in-between the supply air channels.

2. The dual mode impeller assemby of claim 1, further comprising a circular formed air filter arranged on the second side of the dual mode impeller, the circular formed air filter having a first side facing towards the dual mode impeller for receiving the supply air that flows out of the outer orbital portion of the second side of the dual mode impeller.

3. The dual mode impeller assembly of claim 2, further comprising a longitudinal central duct, at the second side of the dual mode impeller, for separating supply air on an outside of the longitudinal central duct and exhaust air on an inside of the longitudinal central duct,
wherein a first portion of the longitudinal central duct comprises a diameter that corresponds to the diameter of the central portion of the second side of the dual mode impeller,
wherein the longitudinal central duct is arranged in a sealing manner to the dual mode impeller such that substantially no air between supply air flow and exhaust air flow can be mixed, and
wherein at least a portion of the circular formed air filter is arranged over and outside the longitudinal central duct.

4. The dual mode impeller assembly of claim 1, further comprising a circular formed static air director arranged in a path of the supply air flow on the second side of the dual mode impeller, the circular formed static air director comprising foils arranged within an orbital flow-through path peripheral outside of a central duct, wherein the foils of the air director are configured to stop most rotational forces of the supply air that result from the rotation of the dual mode impeller.

5. he dual mode impeller assembly of claim 4, wherein the foils have two or more entrance heights to reduce a surfing effect that occurs when encountering boundary layers at a low angle approach.

6. The dual mode impeller assembly of claim 1, wherein the dual mode impeller further comprises a centrally longitudinal arranged motor shaft casing with a central recess for receiving and holding a portion of a motor shaft.

7. The dual mode impeller assembly of claim 6, wherein the motor shaft casing comprises one or more of (A) a resilient material, (B) a male-female formed protrusion and recess, (C) a bolt and nut connection, (D) click connectors, or (E) a splint fixation of axle in center duct of impeller assembly for providing a holding force on the motor shaft.

8. The dual mode impeller assembly of claim 1, further comprising:
a heat exchange module arranged in a longitudinal direction on the second side of the impeller, wherein the heat exchange module is arranged to spin around a half pipe formed center duct structure, the heat exchange module further comprising:
an encircling collector channel for receiving supply air flowing from the outer orbital portion of the second side of the dual mode impeller leading the supply air to and through one longitudinal half of the heat exchange module, and exhaust air flow through the other longitudinal half of the heat exchange module,
a center duct structure comprising a half pipe structure to separate the air flows inside the heat exchange module in two longitudinal halves, the center duct structure further having center duct knives on sides of the center duct structure extending outward on either side, the center duct knives having a radially peripheral end form adapted to a curvature of an inside of the heat exchange module, and
a sleeve air guide assembly comprising static outside flow separator knives having an inward profile corresponding to a tapering outer form of the heat exchange module, and an outward profile corresponding to an inside of a unit casing, the center duct knives and the static outside flow separator knives being arranged longitudinally aligned, pair wise, on the inside of the heat exchange module and an outside of the heat exchange module.

9. The dual mode impeller assembly of claim 3, wherein the dual mode impeller and the circular formed air filter are connected together in a rotating relationship, wherein the circular formed air filter is pipe formed and extends in a generally longitudinal direction over a portion of the second side of the dual mode impeller and a portion of the longitudinal central duct, and providing, in a direction generally perpendicular to the longitudinal direction supply air flow path through the air filter.

10. The dual mode impeller assembly of claim 8, wherein the heat exchange module and a circular formed air filter are connected together in a rotating relationship, wherein the circular formed air filter extends in a direction generally perpendicular to the longitudinal direction, and providing a longitudinal supply air flow path through the air filter.

11. The dual mode impeller assembly of claim 1, wherein a ventilation unit comprises the dual mode impeller assembly, wherein the ventilation unit further comprises a peripheral encircling flow guide and an indoor cover for termination of an indoor side of the ventilation unit.

12. The dual mode impeller assembly of claim 11, wherein the flow guide is defined by an assembly able to partially restrict airflow in one or two directions.
